(19) United States
(12) Patent Application Publication
(10) Pub. No.: US 2002/0042346 A1
(43) Pub. Date: Apr. 11, 2002

(54) Systems for delivering moisture to plants and soils

(75) Inventors: Mark William Hamersky, West Chester, OH (US); Steven Daryl Smith, Fairfield, OH (US)

Correspondence Address: Catherine U. Brown, The Procter & Gamble Co., Miami Valley Labs, P.O. Box 538707, Cincinnati, OH, 45253-8707, US

(73) Assignee: The Procter & Gamble Co.

(21) Appl. No.: 09/891,476

(22) Filed: Jun. 26, 2001

Related U.S. Application Data
(60) Provisional application No. 60/226,741, filed on Aug. 21, 2000.

(51) Int. Cl. A01N 25/10

(52) U.S. Cl. 504/361; 514/772.4

(57) ABSTRACT

Compositions provide dry soils, plants, or both, with moisture, and optionally, other active ingredients. The compositions can be used as the sole source of moisture for a growing plant or as an adjunct source during periods of diminished watering. The compositions are particularly well suited for use in household and potted plant applications. The compositions include an active ingredient selected from the group consisting of a polymer, a surfactant, and combinations thereof.

### CROSS REFERENCE

This application claims priority under 35 U.S.C. § 119 (e) to Provisional Patent Application Ser. No. 60/226,741 filed on Aug. 21, 2000 and to Provisional Patent Application Ser. No. to be assigned filed on Apr. 27, 2001.

### FIELD OF THE INVENTION

This invention relates to compositions, systems, methods, and articles of manufacture that provide soils, plants, or both, with moisture, and optionally, other active ingredients. The compositions can be used as the sole source of moisture for a growing plant or as an adjunct source during periods of diminished watering. The compositions, systems, methods, and articles of manufacture are particularly well suited for use in household and potted plant applications, but may also be applied to larger scale (e.g., farming) applications.

### BACKGROUND OF THE INVENTION

Soils, such as potting soils are commercially available from companies such as the Scotts Company of Marysville, Ohio. Commercially available potting soils typically contain about 40 to about 50% water. It would be desirable to store, ship, and supply potting soils dry to minimize weight and thus costs (e.g., shipping). However, dry soils, such as potting soils, suffer from the drawback that when a user attempts to wet the soil, channeling and run-through may occur. Channeling means void spaces form in the soil. Run-through means that the soil does not absorb water to its full capacity because water added to dry soil does not contact the entire surface area of the soil. This causes plants, seeds, or both, in the soil to receive insufficient water.

Plants require specific amounts of moisture to germinate, grow, and remain viable. Water serves many purposes, inter alia, as a transport for nutrients, and for support of cellular structure. Since antiquity irrigation has been a means for providing moisture to cultivated flora, inter alia, crops. Provided the source of water is plentiful, the means for delivering water is neither inexpensive nor a burden to available resources, for example, not prohibitively labor intensive, irrigation is a method of choice in diminished rain fall and arid environments.

However, even water that is delivered by rainfall or irrigation does not all go to the plant. Evaporation, run off, and other factors lead to the loss of water. Therefore, it is not enough to have an approximate amount of water available to the particular flora but an excess amount.

There is a long felt need in the art for a means for delivering sufficient moisture to soils and cultivated flora, inter alia, crops, trees, flowers, and potted plants that releasably controls the amount of water and does not involve the expense of an irrigation system or which is based on unreliable rainfall amounts.

### SUMMARY OF THE INVENTION

This invention relates to compositions, systems, methods, and articles of manufacture that provide soils, plants, or both, with moisture, and optionally, other active ingredients. It has been surprisingly discovered that dry soil rewetting can be improved, moisture can be controllably delivered to a plant, or both, by a composition. In addition, the compositions of this invention can be used to deliver other beneficial agents to the soil, plant, or both. This invention further relates to a system for providing moisture and optionally other ingredients to plants or other cultivated flora by a means that does not have the expensive requirement of an irrigation system and that does not require daily management by the user.

The compositions typically comprise:

A. an active ingredient selected from the group consisting of

I. a water soluble or dispersible polymer,

II. a surfactant, and

III. a combination of ingredients I and II; and

B. the balance carriers and other adjunct ingredients.

The adjunct ingredients are preferably selected from the group consisting of:

a) a stabilizer;

b) an insecticide;

c) a fertilizer comprising:

i) a source of available nitrogen;

ii) optionally a source of available phosphorous;

iii) optionally a source of available potassium;

iv) optionally a source of heavy metals; and

v) the balance inert ingredients, carriers, and solubility aids; and

d) combinations thereof.

The invention further relates to a means to deliver preferred levels and types of active ingredients to the soil.

This invention further relates to a means for improving wettability of dry soil. The means comprises the compositions of the present invention in various forms, inter alia, as a solid or a fluid such as a sprayable liquid, a pourable liquid, a gel, etc., or the composition can be delivered in conjunction with an article of manufacture as described herein.

This invention further relates to a means for delivering moisture to a plant that comprises the compositions of the present invention in various forms, inter alia, as a solid, sprayable liquid, soil injectable solution, etc. or the composition can be delivered in conjunction with an article of manufacture as described herein.

These and other objects, features, and advantages will become apparent to those of ordinary skill in the art from a reading of the following detailed description and the appended claims.

### DETAILED DESCRIPTION OF THE PREFERRED EMBODIMENTS

All amounts, percentages, ratios and proportions herein are by weight, unless otherwise specified. All temperatures are in degrees Celsius (° C.) unless otherwise specified. All documents cited are in relevant part, incorporated herein by reference. The following is a list of definitions, as used herein.

### Definitions

“Anaerobically biodegradable” means the ability of a polymer to be converted by microbes to the lowest metabolic constituent endpoints, namely, water, carbon dioxide, and methane, said metabolic endpoints are achievable under reduced or depleted oxygen conditions.

“Cps” means centipoise as measured by ASTM Standard D4287 performed at low shear rates (0.1-100 s⁻¹).

“EO” means ethylene oxide.

“PO” means propylene oxide.

This invention relates to compositions that provide soils, plants, or both, with moisture, and optionally, other active ingredients. The compositions typically comprise:

A. an active ingredient selected from the group consisting of

I. a water soluble or dispersible polymer,

II. a surfactant, and

III. a combination of ingredients I and II; and

B. the balance carriers and other adjunct ingredients.

Viscosity of the composition depends on various factors, including the exact ingredients selected for A and B and the form of the composition. The composition may be a solid or a fluid, such as a liquid or gel. When the composition is a liquid, e.g., a sprayable liquid or pourable liquid, and ingredient A is I or III; the composition has a viscosity of from about 10 centipoise (cps), preferably about 100 cps, more preferably from about 250 cps, still more preferably from about 500 cps, most preferably from about 800 cps to about 5000 cps, preferably to about 3000 cps, more preferably to about 1500 cps, most preferably to about 1000 cps. In an alternative embodiment of the invention, the composition is a solid (e.g., granules or powder). When the composition is a soil injectable solution, such as a gel, the viscosity may be about 10 cps to greater than or equal to about 500,000 cps.

Ingredient A imparts wettability to soil, controlled release of moisture to plants, or both. Ingredient I is a water soluble or water dispersible polymer capable of absorbing and controllably releasing water once the composition is delivered to soil, thereby providing controlled release of moisture. Ingredient I may also impart some wettability to the soil. Ingredient II is a surfactant that imparts wettability to the soil. Ingredient II may also impart some water absorption and controlled release properties.

The compositions of this invention release moisture in a manner which is utilizable to the plant.

### Polymers

Ingredient I is a water soluble or dispersible polymer. The polymers of this invention can be biodegradable or non-biodegradable. When the composition will be used to pre-treat soil, the polymer is preferably non-biodegradable. When the composition will be used to post-treat soil, the polymer is preferably biodegradable. Preferred biodegradable polymers are anaerobically biodegradable polymers. The polymer is typically not crosslinked. Typically, the amount of Ingredient I in the composition is 0 to about 20%, preferably about 0.01 to about 20%. The composition is designed to deliver and maintain certain levels of polymer to the soil, typically from about 0.1% to about 10%, preferably about 0.25% to about 5%, more preferably about 0.5% to about 2%, based on the weight of the soil. However, these amounts are meant to be exemplary, not limiting.

### Vinyl Polymers and Copolymers

One preferred class of polymer according to the present invention are polymers and copolymers which are herein defined as “vinyl monomers.” For the purposes of the present invention the term “homopolymer” will stand for polymers which comprise only one monomer, inter alia, polyvinyl alcohol, but the term “polymer” will be used interchangeably herewith. The term “polymer” will also be used interchangeably with the term “copolymer” throughout the present specification when describing polymeric materials in general and when no delineation between “homopolymer” and “copolymer” is required. “Vinyl Polymers” are homopolymers which comprise one or copolymers which comprise two or more monomers having the formula:

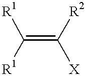

wherein each R¹ is independently hydrogen, C₁-C₁₂ alkyl, C₁-C₁₂ alkoxy, phenyl, substituted phenyl, benzyl, substituted benzyl, carbocyclic, heterocyclic, and mixtures thereof; R² is hydrogen, C₁-C₁₂ alkyl, and mixtures thereof; X is hydrogen, —(CH₂)ₘOH, —(CH₂)ₘCOR, —(CH₂)ₘCH₂OCOR′, wherein R is —OR′, —N(R′)₂, —(CH₂)ₙN(R″)₂, and mixtures thereof; each R′ is independently hydrogen, C₁-C₈ alkyl, C₂-C₈ hydroxyalkyl, —(CH₂)ₙN(R″)₂, and mixtures thereof; wherein R″ is independently hydrogen, C₁-C₄ alkyl, and mixtures thereof; the index m is from 0 to 6, the index n is from 2 to 6. A preferred R¹ is pyrrolidone which provides polyvinyl pyrrolidone as a homopolymer. Vinyl polymers are generally non-biodegradable.

Another embodiment of the present invention relates to “crosslinkable vinyl monomers” having the formula:

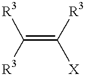

wherein X is the same as defined herein above; R³ is R¹, —(CH₂)ₘCH₂OH, —(CH₂)ₘCO₂R′, —(CH₂)ₘCH₂OCOR′ wherein each R′ is independently hydrogen, C₁-C₈ alkyl, and mixtures thereof; the index m is from 0 to 6. Non-limiting examples of “crosslinkable vinyl monomers” include maleic acid, fumaric acid, itaconic acid, citraconic acid, hydromuconic acid, vinyl acetate, and mixtures thereof.

Non-limiting examples of preferred vinyl monomers include, ethylene, propylene, butylene, styrene, vinyl alcohol, crotyl alcohol, acrylic acid, styrylacetic acid, methacrylic acid, crotonic acid, 3,3-dimethyl-acrylic acid, methyl acrylate, ethyl acrylate, n-propyl acrylate, isopropyl acrylate, butyl acrylate, methyl methacrylate, ethyl methacrylate, n-propyl methacrylate, isopropyl methacrylate, butyl methacrylate, methyl 3,3-dimethyl-acrylate, ethyl 3,3-dimethyl-acrylate, n-propyl 3,3-dimethyl-acrylate, isopropyl 3,3-dimethyl-acrylate, butyl 3,3-dimethyl-acrylate, acrylamide, N-methyl acrylamide, N,N-dimethyl acrylamide, N-(aminoethyl) methyl acrylamide, vinyl acetate, and mixtures thereof.

### Polysaccharides

The compositions of the present invention may also comprise one or more polysaccharide or polysaccharide derivatives as a suitable polymer or copolymer. Non-limiting examples of polysaccharides include cellulosic polymers such as carboxy methyl cellulose, carboxy ethyl cellulose, carboxy isopropyl cellulose, the salts thereof, hydroxyalkyl cellulose, xanthan, pectin, gum arabic, guar gum, carageenan, agar, locust bean, starch and the like. Polysaccharides are preferred for use as ingredient I. Polysaccharides are generally biodegradable.

### Polyalkyleneoxy Polymers

Other preferred polymers according to the present invention are the polyalkyleneoxy homopolymers and copolymers. Non-limiting examples include polyethylene oxides, polyethylene glycols (PEG), methoxy polyethylene glycols (MPEG), and block co-polymers of polyethylene glycol and polypropylene glycol (EO/PO co-polymers, wherein said PO unit can be 1,2-propylene, 1,3-propylene, or mixtures thereof), for example PLURONICS® available ex BASF. Also preferred are EO/PO/EO and PO/EO/PO co-polymers. The polyalkyleneoxy polymer has a molecular weight greater than or equal to 10,000 grams per mole.

Other preferred polymers according to this invention include poly acrylic acid/acrylamide copolymers, polystyrene sulfonate, and polyvinylpyrolidone.

The molecular weight of the polymer depends on various factors including the type of polymer, however, generally, the polymer has a molecular weight of about 1,000 to about 1,000,000.

### Surfactants

Ingredient II is a surfactant that is not harmful to plants. The surfactants of this invention can be biodegradable or non-biodegradable. When the composition will be used to pre-treat soil, the surfactant is preferably non-biodegradable. When the composition will be used to post-treat soil, the surfactant is preferably biodegradable. In embodiments where the surfactant degrades, the composition can be reapplied to the soil periodically to maintain the benefits of the composition.

It is not widely recognized the types or levels of surfactant in soil that have phytotoxic or inhibitory effects. The level of surfactant needs to be maintained at certain levels to avoid injury to existing or germinating plants. The compositions are designed to deliver about 0.001% to about 1% surfactant, preferably about 0.01% to about 0.5%, more preferably about 0.05% to about 0.2% to the soil. Ingredient II may be a nonionic surfactant, an amphoteric surfactant, or a combination of two or more surfactants. In limited amounts, anionic or cationic surfactants may also be used, although it is recognized these show stronger potential inhibitory effects on plant growth. The exact amount of ingredient II depends on various factors including the specific surfactant selected. However, the amount of ingredient II is typically about 0 to about 5% of the composition, preferably about 0.01% to about 5%. The composition is appropriately diluted or dosed to deliver the preferred amounts to the soil.

Suitable nonionic surfactants include copolymers of polyethylene oxide and polyalkylene oxides, having molecular weights less than 10,000 grams per mole. Preferred polyalkyleneoxy surfactants include block co-polymers of polyethylene glycol and polypropylene glycol (EO/PO co-polymers, wherein said PO unit can be 1,2-propylene, 1,3-propylene, or mixtures thereof), EO/PO/EO, and PO/EO/PO surfactants. PO/EO/PO surfactants are preferred. Block copolymers of polyethylene glycol and polybutylene glycol can also be employed. The polyalkyleneoxy surfactants are generally non-biodegradable. Suitable surfactants include PLURONIC® surfactants, which are known in the art and commercially available from BASF Corporation. A preferred PLURONIC® surfactant is 25R2, which has a total molecular weight of 3,100, 20% of which represents EO units.

Nonionic surfactants may also include alkylated polyalkylene oxides, such as C6-C18 alkyl polyethoxylates. Many closely related materials, including combinations of alkyl polyethyleneoxide polypropyleneoxide surfactants, and alkyl capped alkyl polyalkylene oxides derivatives. These surfactants may be biodegradable or non-biodegradable, depending on a few factors, such as degree of branching in the alkyl group, and use of poly(C3 or higher) alkyleneoxide substituents. Suitable surfactants include Neodol surfactants, which are known in the art and commercially available form Shell Corporation.

Other suitable classes of nonionic surfactants include alkyl polyhydroxy derivatives, including but not limited by alkyl polyglucosides, polyhydroxy fatty acid amides, acyl saccharides, and ethoxylated sorbitol esters.

Suitable amphoteric surfactants include compounds in the class of betaines. Preferred betaines include MIRANOL® surfactants, which are known in the art and commercially available from Rhodia. A preferred MIRANOL® surfactant is MIRANOL® Ultra 32 (disodium lauroampho diacetate sodium glycolate).

In a preferred embodiment of the invention, Ingredient A comprises a combination of ingredients I and II.

### Carriers

The compositions of this invention may comprise one or more carriers. Suitable carriers include solvents, preferably water.

### Adjunct Ingredients

The compositions of this invention may comprise one or more adjunct ingredients non-limiting example of which are plant nutrients including fertilizers and heavy metals, insecticides, herbicides, stabilizers, wetting agents, and the like.

### Fertilizers

The compositions of the present invention comprise from about 0.01%, preferably from about 0.05%, more preferably from about 1%, most preferably from about 3% to about 7%, preferably to about 6%, more preferably to about 5%, most preferably to about 4% by weight, of a fertilizer on a dry weight basis. If the dry composition is added to water to generate the viscous polymer solution, the amount comprising the composition will be lower in concentration. A preferred embodiment of the present invention comprises a fertilizer comprising:

i) from about 10% to about 100% by weight, a source of available nitrogen;

ii) optionally from about 1% to about 25% by weight, a source of available phosphorous;

iii) optionally from about 1% to about 25% by weight, a source of available potassium;

iv) optionally from about 0.01% to about 5% by weight, a source of heavy metals; and

v) the balance inert ingredients, carriers, and solubility aids.

Non-liming examples of sources of available nitrogen include, urea, ammonium nitrate, potassium nitrate, and mixtures thereof. Non-limiting examples of available phosphorous includes ammonium phosphate, hydrated phosphorous pentoxide, and mixtures thereof. Available sources of potassium include any suitable water soluble potassium salt. Non-limiting examples of sources of heavy metals include chelated iron (chelated with EDTA), manganese, and zinc. However, the formulator may add to the polymers of the present invention one or more commercially available fertilizers, inter alia, Scotts Master Collection® (15N, 13P, 13K), Schultz Plant Food (20N, 30P, 20K).

### Insecticides

The compositions of the present invention may comprise from about 0.01%, preferably from about 0.05%, more preferably from about 0.1%, most preferably from about 0.5% to about 1%, preferably to about 0.75% by weight, of one or more insecticides. Non-limiting examples of suitable insecticides include 1-naphthalenol (Sevin®), phosphorothioic acid, O,O-diethyl O-[6-methyl-s-(1-methylethyl)4-pyrimidinyl] ester (Diazinon®), phosphorothioic acid O,O-diethyl O-(3,5,6-trichloro-2-pyridinyl) ester (Dursban®), and mixtures thereof.

### Stabilizers

The compositions of the present invention may comprise from about 0.001%, preferably from about 0.005%, more preferably from about 0.01%, most preferably from about 0.05% to about 1%, preferably to about 0.5%, more preferably to about 0.25%, most preferably to about 0.1% by weight, of the amount of polymer which is present in said composition. For example, if the composition comprises 10% by weight of a polymer, said composition comprises at least 0.0001% by weight of a stabilizer when said stabilizer is present.

Non-limiting examples of stabilizers include tetrakis[methylene(3,5-di-tert-buty;1-4-hydroxyhyrocinnamate)] methane (Irganox 1010®), 2,6-bis(1,1-dimethylethyl)-4-methylphenol (BHT), and mixtures thereof.

The compositions described above may be prepared by any convenient means such as combining all ingredients and mixing at room temperature or at elevated temperature (e.g., up to about 33° C.

### Methods of Use

This invention further relates to methods of using the compositions described above, to provide wettability to dry soil or to provide controlled release of moisture to plants in soil treated with a composition described above, or both. The composition may be used to pre-treat the soil or post-treat the soil. “Pre-treat” generally means that the composition is applied to the soil, e.g., by a manufacturer, before the soil reaches an end user. “Post-treat” means that the composition is applied to the soil after the soil is used, e.g., by an end user who applies the composition after putting the soil in a pot with or without a plant or seed.

In one embodiment of the invention, the method comprises applying a composition described above to soil, wetting the soil with water, and optionally planting seeds and/or plants in the soil. The composition may be periodically reapplied, for example, when the surfactant and/or polymer degrades over time. The composition is preferably periodically reapplied when ingredient A is biodegradable. The composition is reapplied with a frequency (e.g., once per month) sufficient to maintain the benefits described above.

In one embodiment of the invention, the composition described above is a liquid applied by, e.g., spraying, sprinkling, pouring, or placing a flexible, water dissovable package on the surface of the soil. Optionally after this, the soil may be dried to remove some or all of any carrier such as water that may be present. This embodiment offers the advantage that when the soil used is potting soil, it may be stored and shipped in its dry form, and an end user merely needs to water the soil to effectively rewet it.

In an alternative embodiment of the invention, a composition described above is applied by injection beneath the surface of the soil. Preferably, in this embodiment, ingredient A is selected from the group consisting of ingredient I and ingredient III.

In an alternative embodiment of the invention, ingredient I may be diluted in water and applied to the soil, e.g., by application to the surface of the soil or mixing with the soil. The soil may then optionally be dried. Ingredient II may then be applied to the soil, e.g., by application to the surface of the soil or by mixing with the soil. The soil may then optionally be dried again. Alternatively, this method may be employed except that the order of addition of ingredients I and II is reversed.

In a preferred embodiment of the invention, a first composition comprising ingredient II and ingredient B may be applied to the soil. The soil is then optionally dried. This embodiment offers the advantage that the soil may be shipped dry, as described above. A second composition comprising ingredient I and ingredient B may be applied to the soil before or after drying and/or shipping.

When the composition will be used to post-treat soil, a kit may be marketed. The kit preferably contains soil, a composition described above, and information, instructions, or both, that describe to a user how to use the composition with the soil. For example, in the preferred embodiment described above, the soil treated with a first composition comprising a surfactant may be packaged with (or separately from) a second composition comprising ingredient II and ingredient B. The kit preferably contains information, instructions, or both, that describe to a user how to use the second composition with the soil and/or how to reapply the second composition periodically.

### EXAMPLES

These examples are intended to illustrate the invention to one of ordinary skill in the art and should not be interpreted as limiting the scope of the invention set forth in the claims.

### Examples 1-20

### Compositions

Compositions are prepared by combining the ingredients in Tables I-V, below.

TABLE I

weight %

| Ingredients | 1 | 2 | 3 | 4 |
|---|---|---|---|---|
| Polymer¹ | 0.7 | 1.3 | 2 | 3.3 |
| Water | balance | balance | balance | balance |

¹Carboxy methyl cellulose having an average molecular weight of about 250,000 daltons.

TABLE II

weight %

| Ingredients | 5 | 6 | 7 | 8 |
|---|---|---|---|---|
| Polymer² | 0.5 | 1.0 | 2.5 | 6.0 |
| Water | balance | balance | balance | balance |

¹Polyethylene glycol having an average molecular weight of about 200,000 daltons.

TABLE III

weight %

| Ingredients | 9 | 10 | 11 | 12 |
|---|---|---|---|---|
| Polymer¹ | 0.5 | 1.0 | 2.5 | 6.0 |
| Water | balance | balance | balance | balance |

¹Polymethyl methacrylate/polyacrylic acid copolymer having an average molecular weight of about 200,000 daltons.

TABLE IV

weight %

| Ingredients | 13 | 14 | 15 | 16 |
|---|---|---|---|---|
| Polymer¹ | 5 | 4 | 6 | 8 |
| Water | balance | balance | balance | balance |

¹Carboxy methyl cellulose having an average molecular weight of about 90,000 daltons.

TABLE V

weight %

| Ingredients | 17 | 18 | 19 | 20 |
|---|---|---|---|---|
| Polymer¹ | 0.1 | 0.2 | 0.4 | 0.5 |
| Water | balance | balance | balance | balance |

¹Carboxy methyl cellulose having an average molecular weight of about 700,000 daltons.

### Reference Example 1

### Water Retention Experimental Protocol

Treatments are carried out on small (150 g) portions of soil in pots that are kept in a chamber maintained at 20% relative humidity and 22° C. The weight is recorded with time.

### Example 21

A sample is prepared by injecting a measured amount (25 g) of treatment (1-2 wt % polymer dissolved in water) beneath the soil. The sample is tested according to Reference Example 1. Polyethylene oxide having a molecular weight of 100,000 is used as the polymer. The results are in Table VI.

### Example 22

A sample is prepared by injecting a measured amount (25 g) of treatment (1-2 wt % polymer dissolved in water) beneath the soil. The sample is tested according to Reference Example 1. Poly(acrylamide/acrylic) acid copolymer having a molecular weight of 78,000 is used as the polymer. The results are in Table VI.

### Example 23

A sample is prepared by injecting a measured amount (25 g) of treatment (1-2 wt % polymer dissolved in water) beneath the soil. The sample is tested according to Reference Example 1. Carboxy methyl cellulose having a molecular weight of 250,000 is used as the polymer. The results are in Table VI.

### Comparative Example 1

Hydrated Agrosoke pellets (which are chemically cross-linked gel pellets available from Agrosoke International) are mixed with the soil and the control water is dripped on top of the soil (to mimic watering a plant). The sample is tested according to Reference Example 1. The results are in Table VI.

### Comparative Example 2

Water is dripped on top of untreated soil. The sample is tested according to Reference Example 1. The results are in Table VI.

TABLE VI
Retention Data

| Treatment | Day 1 weight | Day 7 Weight |
|---|---|---|
| Comparative Example 2 | 177 | 124 |
| Example 23 | 177 | 138 |
| Example 21 | 180 | 139 |
| Example 22 | 178 | 140 |
| Comparative Example 1 | 177 | 125 |

### Comparative Example 3

Water is injected beneath the soil surface as in Example 21. The sample is tested according to Reference Example 1.

Examples 21-23 and Comparative Examples 1-3 show that the polymer solutions retain water longer than traditional watering or distributing a chemically cross-linked gel placed beneath the soil. The location of the water also plays a role, i.e., water alone injected beneath the soil surface performs better than water placed on the surface, but not as well as a polymer solution injected beneath the soil.

### Example 24

Four bean seeds are placed in a pot with soil treated as in Example 23. This treatment allows for germination and substantial growth.

### Comparative Example 4

Four bean seeds are placed in a pot with soil treated as in Comparative Example 2. Germination, but no substantial growth, is observed.

### Comparative Example 5

Four bean seeds are placed in a pot with soil treated with hydrated Agrosoke pellets. Germination, but no substantial growth, is observed.

### Example 25

### Method for Watering Plants

200 g of carboxy methyl cellulose (CMC) (2% aqueous solution) is injected into the soil of a potted marigold. The weight of the plant and soil are recorded with time and the visual appearance is monitored with digital photography after 21 days. No additional watering is done to the marigold.

### Comparative Example 6

Example 25 is repeated except that the commercial product, Agrosoke, is used according to package directions to treat the soil instead of the carboxy methyl cellulose solution.

### Comparative Example 7

Example 25 is repeated except no soil treatment is used.

Example 25 and Comparative Examples 6-7 show that the carboxy methyl cellulose injection results in a much healthier plant and Agrosoke provides little to no benefit over conventional watering in this test protocol.

### Reference Example 2

### Method for Watering Plants

A solution is prepared by dissolving carboxymethylcellulose in water. The solution is poured on top of 150 g of soil (which contains about 45 g water). Water retention (expressed by weight of the sample) is measured periodically over 6 days.

### Example 26

A solution is prepared and tested according to Reference Example 2. The solution contains 1.3% carboxy methyl cellulose.

### Example 27

A solution is prepared and tested according to Reference Example 2. The solution contains 3.3% carboxy methyl cellulose.

### Example 28

A solution is prepared and tested according to Reference Example 2. The solution contains 5% carboxy methyl cellulose.

### Comparative Example 8

A solution is prepared and tested according to Reference Example 2. The solution contains 0.1% carboxy methyl cellulose.

### Comparative Example 9

A sample is prepared and tested according to Reference Example 2, except that water is used instead of a solution.

Examples 26-28 and Comparative Examples 8-9 show that an optimum in carboxy methyl cellulose concentration is observed in this test protocol. Water retention increases with carboxy methyl cellulose concentration between about 0.1% and about 3.3%. However, at about 5% the overall benefit is similar to that obtained at about 1.3%. Without wishing to be bound by theory, it is thought that this is likely a manifestation flow resistance arising from viscosity differences among the solutions. It appears that too little carboxy methyl cellulose has little to no benefit over water, and too much carboxy methyl cellulose creates a viscous liquid that has difficulty in penetrating/permeating through the soil. In terms of water-retention benefit, the 3.3% solution is about equivalent to the carboxy methyl cellulose injection discussed above. However, in comparing these two methods, it is thought that pouring a solution on top would be easier for a consumer to perform and appreciate. The injection would require a device to deliver the composition beneath the soil and would be a change in habit for a consumer.

### Reference Example 3

### Soil Rewetting

30 grams dry potting soil from the Scotts Company of Marysville, Ohio is placed in a small (4″) pot. The experiments are conducted at ambient conditions (25° C. and 40% relative humidity. The “initial absorption” is the amount of weight uptake exhibited by the pot until the first sight of leakage (run-through). The “ultimate capacity” represents the total amount of uptake displayed by the pot over a 2 minute period and represents total water capacity for the pot. In some cases, the soil is pretreated with a solution and then dried (referred to as “deposition”). For either initial or ultimate capacity, the larger the absorbed amount, the better the performance of the treatment.

### Examples 29-38 and Comparative Example 10

Samples are prepared according to Reference Example 3. The compositions of the samples and the results are shown in Table VII, below.

TABLE VII

| | | | Initial | Ultimate |
|---|---|---|---|---|
| | Treatment | | absorption | capacity |
| Example | (on 30 g dry soil) | | (g) | (g) |
| Example 29 | Miranol Surfactant solution | Rhodia | 107 | 122 |
| | | 0.5 wt % Miranol | | |
| | | DI water | | |
| Example 30 | Pluronic 25R2 solution | BASF | 108 | 111 |
| | | 0.5% Pluronic | | |
| | | DI water | | |
| Example 31 | Miranol Surfactant deposition | 0.5% Miranol | 77 | 139 |
| | | DI water | | |
| | | 30 g mixture added to 30 g | | |
| | | soil - then dried | | |
| Example 32 | Tetronic 90R4 solution | BASF | 58 | 112 |
| | | 0.5% Tetronic | | |
| | | DI water | | |
| Example 33 | CMC/miranol solution | Aldrich | 64 | 105 |
| | | CMC: M = 250k, 1.3% | | |
| | | solids | | |
| | | Miranol: 0.2% | | |
| | | DI water | | |
| Example 34 | Polystyrene sulfonate deposition | Scientific Polymer | 53 | 110 |
| | | Products | | |
| | | M = 70,000 | | |
| | | 2 wt % polystyrene | | |
| | | sulfonate | | |
| | | DI water | | |
| Example 35 | Polystyrene sulfonate solution | 30 g above solution added | 22 | 78 |
| | | to | | |
| | | 30 g dry soil | | |
| Example 36 | PVP solution | Aldrich | 23 | 52 |
| | | M = 10,000 | | |
| | | 1 wt % polymer | | |
| | | DI water | | |
| Example 37 | CMC solution | M = 250,000 | 20 | 54 |
| | | 0.75 wt % polymer | | |
| | | DI water | | |
| Example 38 | PEG solution | Aldrich | 13 | 48 |
| | | M = 10,000 | | |
| | | 1 wt % polyethylene glycol | | |
| | | DI water | | |
| Comparative | Tap water | | 13 | 35 |
| Example 10 | | | | |

Table VII shows that the best two performers are MIRANOL® (an amphoteric surfactant) and PLURONIC® 25R2 (a nonionic surfactant). The differing routes (i.e., deposition and solution) mentioned above are evaluated in re-wetting of dried potting mix (Scotts). The surfactant treatment appears to be more efficient in re-wetting the soil, although the polymer (polystyrene sulfonate) system is by no means optimized. Without wishing to be bound by theory, it is expected that the polymer system will deliver a longer-lasting benefit from its reluctance to migrate, which should enhance substantivity to the soil. Another interesting feature of the data is the ability of the surfactant solution to initially rewet to ˜90% of the 2 minute watering. All the other treatments exhibit less rapid wetting. In effect, the use of the surfactant solution allows the consumer to deliver the maximum amount of water to dried soil in the shortest amount of time.

We claim:

1. A soil treatment composition comprising:
A. an active ingredient selected from the group consisting of
I. a water soluble or dispersible polymer,
II. a surfactant,
III. combinations of I and II; and
B. a balance carriers and adjunct ingredients;
wherein the composition has form selected from the group consisting of solids and fluids; and with the provisos that
when the fluid is a liquid and ingredient a is I or III, then the composition has a viscosity of about 10 cps to about 5000 cps, and
when the composition is a gel, then the composition has a viscosity of about 10 cps to greater than or equal to about 500,000 cps.

2. A composition according to claim 1 wherein said polymer is a homopolymer or copolymer comprising one or more monomers having the formula: 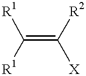
wherein each R¹ is independently hydrogen, C₁-C₁₂ alkyl, C₁-C₁₂ alkoxy, phenyl, substituted phenyl, benzyl, substituted benzyl, carbocyclic, heterocyclic, and mixtures thereof; R² is hydrogen, C₁-C₁₂ alkyl, and mixtures thereof; X is hydrogen, —(CH₂)ₘOH, —(CH₂)ₘCOR, —(CH₂)ₘCH₂OCOR′, wherein R is —OR′, —N(R′)₂, —(CH₂)ₙN(R″)₂, and mixtures thereof; each R′ is independently hydrogen, C₁-C₈ alkyl, C₂-C₈ hydroxyalkyl, —(CH₂)ₙN(R″)₂, and mixtures thereof; wherein R″ is independently hydrogen, C₁-C₄ alkyl, and mixtures thereof; the index m is from 0 to 6, and the index n is from 2 to 6.

3. A composition according to claim 1 wherein said polymer is a polysaccharide or derivative thereof.

4. A composition according to claim 3 wherein said polymer is selected from the group consisting of carboxy methyl cellulose, carboxy ethyl cellulose, hydroxy ethyl cellulose, salts thereof, and mixtures thereof.

5. A composition according to claim 1 wherein said polymer is selected from the group consisting of poly(ethylene oxide), polyvinyl alcohol, polyacrylic acid, polyacrylamide/acrylic acid copolymer, poly dimethylamino ethyl methacrylate, carboxy methyl cellulose, hydroxy ethyl cellulose, polyvinyl pyrrolidone, and mixtures thereof.

6. A composition according to claim 1 wherein said polymer is selected from the group consisting of poly acrylic acid/acrylamide copolymers, polystyrene sulfonate, and polyvinylpyrolidone.

7. A composition according to claim 1 wherein said surfactant is selected from the group consisting of nonionic surfactants, amphoteric surfactants, and combinations thereof.

8. A composition according to claim 7, wherein the nonionic surfactant is selected from the group consisting of EO/PO, EO/PO/EO, and PO/EO/PO surfactants.

9. A composition according to claim 7, wherein the amphoteric surfactant is a betaine compound.

10. A composition according to claim 1 further comprising a source of plant nutrients.

11. A composition according to claim 1 further comprising a pesticide.

12. A composition according to claim 1 further comprising a stabilizer.

13. A system for delivering nutrients to plants, said system comprising
A) a composition comprising:
a) an active ingredient selected from the group consisting of
I. a water soluble or dispersible polymer,
II. a surfactant,
III. combinations of I and II; and
b) a stabilizer;
c) an insecticide;
d) a fertilizer comprising:
i) a source of available nitrogen;
ii) optionally a source of available phosphorous;
iii) optionally a source of available potassium;
iv) optionally a source of heavy metals; and
v) the balance inert ingredients, carriers, and solubility aids;
e) the balance carriers and other adjunct ingredients
wherein said composition has a form selected from the group consisting of solids and fluids; and with the provisos that when the fluid is a liquid and ingredient A is I or III, then the composition has a viscosity of about 10 cps to about 5000 cps, and when the fluid is a gel, then the composition has a viscosity of about 10 cps to greater than or equal to about 500,000 cps; and
B) optionally a means for delivery of said composition.

14. A system according to claim 13 wherein said composition is in the form of a solid.

15. A system according to claim 13 wherein said composition is in the form of a liquid.

16. A system according to claim 13 wherein said composition is delivered in a flexible, water dissolvable package.

17. A system according to claim 13 wherein said means for delivery is an article of manufacture capable of spraying an aqueous solution of said composition.

18. A system according to claim 13 wherein said means for delivery comprises an article of manufacture capable of penetrating soil and releasing said composition therefrom.

19. A method of treating soil comprising:
i) applying the composition of claim 1 to the soil.

20. The method of claim 19, further comprising:
ii) periodically reapplying the composition to the soil after step i).

21. The method of claim 20, wherein the composition is reapplied with a frequency sufficient to maintain benefits provided by the composition.

22. The method of claim 20, wherein ingredient A is biodegradable.

23. The method of claim 19, wherein the composition is applied in an amount sufficient to provide about 0.001% to about 1% of ingredient II to the soil.

24. The method of claim 19, wherein the composition is applied to the surface of the soil.

25. The method of claim 19, wherein the composition is injected beneath the surface of the soil.

26. The method of claim 19, further comprising:
ii) drying the soil after applying the composition.

27. The method of claim 26, wherein the composition comprises ingredient I and ingredient B.

28. The method of claim 27, further comprising applying a second composition comprising ingredient II and ingredient B to the soil after step ii).

29. The method of claim 26, wherein the composition comprises ingredients II and ingredient B.

30. The method of claim 29, further comprising applying a second composition comprising ingredient I and ingredient B to the soil after step ii).
